(19) United States
(12) Patent Application Publication
(10) Pub. No.: US 2009/0238940 A1
(43) Pub. Date: Sep. 24, 2009

(54) COLOR-IMPARTING CHOCOLATE COMPOSITIONS AND FOOD ARTICLES MADE THEREFROM

(75) Inventors: Paul D. HORKY, Plymouth, MN (US); Scott D. Johnson, Ephrata, PA (US); Stanley Prawiradjaja, Lititz, PA (US)

Correspondence Address: CARGILL, INCORPORATED, P.O. Box 5624, MINNEAPOLIS, MN, 55440-5624, US

(73) Assignee: CARGILL, INCORPORATED, Wayzata, MN (US)

(21) Appl. No.: 12/406,740

(22) Filed: Mar. 18, 2009

Related U.S. Application Data
(60) Provisional application No. 61/070,235, filed on Mar. 20, 2008.

(51) Int. Cl. A23L 1/275

(52) U.S. Cl. 426/540

(57) ABSTRACT

Disclosed are color-imparting chocolate compositions. The compositions are formulated to have a visual appearance consistent with a conventional chocolate composition, yet include a visually hidden (i.e., hidden to the unaided eye) color-imparting dye. Upon contact with a water-based liquid (e.g., during the act of consuming the chocolate composition), the color-imparting dye is activated and imparts its color to the water-based liquid and/or to a surface wetted or in contact with the water-based liquid.

### CROSS REFERENCE TO RELATED APPLICATION

This application claims the benefit of U.S. provisional application Ser. No. 61/070235 filed 20 Mar. 2008 entitled COLOR-IMPARTING CHOCOLATE COMPOSITIONS AND FOOD ARTICLES MADE THEREFROM, which is hereby incorporated by reference in its entirety.

### BACKGROUND

The ability to provide food articles that have functionality to a consumer beyond merely taste, nutritional content, and calorie content is highly desirable to food companies planning new product releases. Although not primary to the functionality of a food product, the ability to add a novelty aspect and visual interest to the food may provide an additional feature that drives interest and sales. In particular, the ability to add a novelty aspect and visual interest may appeal to children which may be a powerful aspect driving the sales of a new food product.

In view of the foregoing, the ability to add a novelty aspect and visual interest to food products is highly desirable.

### SUMMARY

The present invention provides color-imparting chocolate compositions. The compositions are formulated to have a visual appearance consistent with a conventional chocolate composition, yet they include a visually hidden (i.e., to the unaided human eye) water-soluble color-imparting dye. Upon contact with a water-based liquid (e.g., during the act of consuming the chocolate composition), the color-imparting dye dissolves and imparts its color to the water-based liquid and/or to a surface wetted or in contact with the water-based liquid. In many embodiments, the color-imparting chocolate compositions of the invention are used to provide a novelty effect by releasing the visually hidden color-imparting dye when the food product comprising the color-imparting chocolate composition is consumed and/or is brought into contact with another food product. For example, if the color-imparting chocolate composition is consumed by a human, the color-imparting chocolate composition will impart the color of the dye to the mouth (e.g., tongue, gums, etc.) of the consumer. In a particular example, a chocolate-coated ice cream bar that contains an outer coating of a color-imparting chocolate composition of the invention will transfer the color of the dye to the mouth, tongue, lips, etc. of the person who eats the ice cream bar.

### DETAILED DESCRIPTION

In many embodiments, the color-imparting chocolate compositions of the invention comprise: (i) an anhydrous water-soluble color-imparting dye; and (ii) a chocolate composition. The chocolate composition may be a cocoa-butter based chocolate (see, CFR Title 21.163) or may be a confectionary composition As used herein the term “confectionary composition” refers to a vegetable oil based (i.e., non-cocoa butter-based) product that can be processed similarly to a chocolate product.

Ingredients making up the chocolate compositions of the invention are described in more detail below.

Cocoa Butter-Based Chocolate Compositions and Confectionary Compositions:

In some embodiments, the chocolate compositions comprise cocoa butter-based chocolates as defined, for example, in CFR Title 21.163.

Typical cocoa-butter based chocolate compositions comprise sweet chocolate in an amount of about 15 wt. % or greater; semisweet chocolate in an amount of about 35 wt. % or greater; milk chocolate in an amount of about 10 wt, % or greater; while chocolate in an amount of about 20 wt. % or greater. Typical ingredients for cocoa-butter based chocolates are provided in TABLE 1 below.

TABLE 1
Cocoa-butter Based Chocolate

| | % Limit | | | | | |
|---|---|---|---|---|---|---|
| | Cocoa | Cocoa | Milk | Milk | | |
| Type | Liquor | Butter | Fat | Solids | Sugar | Emulsifiers |
| Sweet | >15 | | | <12 | | <1 |
| Chocolate | | | | | | |
| Semisweet | >35 | | | | | <1 |
| Chocolate | | | | | | |
| Milk Chocolate | >10 | | >3.39 | >12 | | <1 |
| White | | >20 | >3.5 | >14 | <55 | <1.5 |
| Chocolate | | | | | | |

*Based on CFR Title 21.163

In some embodiments, the color-imparting chocolate is in the form of a confectionary composition. Confectionary compositions typically comprise a fat matrix in an amount ranging from about 20 wt. % to about 55 wt. %. The fat matrix may comprise, for example, palm oil, palm kernel oil, soybean oil, canola oil, milk fat, cocoa butter, or mixtures thereof. Also included is a nutritive/nonnutritive sweetener in an amount ranging from about 10% wt. to about 65% wt. Examples of nutritive/nonnutritive sweeteners include sugar, polyol, fibers, dextrose, monatin, rebiana or mixtures thereof. Also included are milk solids, typically in an amount ranging from about 1 wt. % to about 25 wt. %. Milk solids include non fat dry milk, whole milk powder, whey, sodium casemate, calcium casemate, or mixtures thereof. The confectionary composition may also comprise cocoa solids which may be provided in a liquid or powder form and are typically included in an amount ranging from about 1 wt, % to about 15 wt. %. A flavoring may also be present, for example, in an amount ranging from about 0.01 wt. % to about 1.5 wt. %. In many embodiments, the confectionary compositions are provided in the form of coatings or layers in a food article (i.e., a confectionary coating). Typical formula guidelines for a confectionary composition are summarized in TABLE 2 below.

TABLE 2
Confectionary Composition

| | LOWER LIMIT | HIGHER LIMIT |
|---|---|---|
| INGREDIENT | (%) | (%) |
| Fat Matrix | 20 | 55 |
| Nutritive/Nonnutritive | 10 | 65 |
| Bulking Agent (e.g., Sugar, | | |
| Polyols, Fiber) | | |
| Milk Solids | 0.3 | 25 |
| Cocoa Solids | 0 | 15 |
| (liquor/powder) | | |
| Emulsifiers | 0 | 1 |
| Flavorings | 0 | 1.5 |

### Color-Imparting Dye:

Color-imparting chocolate compositions of the invention comprise an anhydrous water-soluble dye. In many embodiments, the dyes include water-soluble versions of artificial coloring compositions that are approved for use in the United States. The anhydrous water-soluble dyes are inactive in a fat-based system such as chocolate, but activate upon contact with water. Contact with water may occur during consumption of a food article comprising the color-imparting chocolate composition or by addition of the food product to a water-based liquid (e.g., milk). When the product is consumed, the water soluble dye dissolves and stains the tongue and the interior of the mouth of the consumer providing a novelty effect.

The color-imparting dye is anhydrous so that it can be mixed with the chocolate composition without causing the chocolate composition to seize. Since chocolate is composed of line, dry particles (cocoa and sugar) and fat (cocoa butter), even a minor amount of water can moisten the dry particles causing them to stick together and form a dull, dry, grainy mass (i.e., to seize).

The anhydrous water soluble color-imparting dye is present in the chocolate composition in an effective amount in order to impart the desired color when the chocolate composition is contacted with a water-based liquid, for example, as occurs when the chocolate composition is consumed. As an upper limit, the color-imparting dye should not be present in an amount so great as to cause the color of the color-imparting dye to be visually identifiable when the chocolate composition is viewed with the unaided eye. That is, the chocolate composition of the invention has a visual appearance that does not reveal the color of the anhydrous water-soluble dye. In this way, the chocolate composition of the invention appears to be a conventional chocolate, for example, having the characteristic deep brown color. In many embodiments, the water-soluble color-imparting agent or dye is typically present in the composition in an amount ranging from about 0.01 wt. % to about 1 wt. %.

Examples of colors include red, blue, green, and yellow. In some embodiments a combination of two or more dyes is made in order to provide the desired color. Suitable color-imparting dyes are available under the designations FD&C Blue No. 1 (Brilliant Blue FCF, E133 (Blue Shade)); FD&C Blue No. 2 (Indigotine, E132 (Dark Blue)); FD&C Green No. 3 (Fast Green FCF, E143 (Bluish Green Shade)); FD&C Red No. 40 (Allura Red AC, E129 (Red Shade)); FD&C Red No. 3 (Erythrosine, E127 (Pink Shade)); FD&C Yellow No. 5 (Tartrazine, E102 (Yellow Shade); FD&C Yellow No. 6 (Sunset Yellow FCF, E110 (Orange Shade)).

### Food Articles:

The color-imparting compositions of the invention can be used in virtually any food article known to include a chocolate or confectionary composition. Representative applications include chocolate chips; ice-cream bars having an outer coating comprising a layer of the color-imparting chocolate; breakfast cereals containing particles (i.e., chips) of the color-imparting chocolate composition or containing a layer or coating of color-imparting chocolate composition; granola or nutrition bars containing the color-imparting chocolate composition of the invention, which may be present as an outer coating, a layer, or in the form of chips dispersed throughout the granola or nutrition bar; bakery inclusions, confectionary products; pretzel coatings; and the like. Yet other embodiments include ready-to-eat cereals; enrobed ice cream novelty products (e.g., dipped cones); enrobed candies; enrobed popcorn; chocolate syrups (e.g., to be drizzled over ice cream); fondue; bars (e.g., as inclusions, bottom coats, top coats, etc.); chocolate bars/pieces; enrobed nuts; raisins; malt balls; enrobed marshmallow products; truffles; glazes/drizzles (like over donuts and other baked goods); pastry fillings; chocolate mints; and sprinkles.

In many embodiments, articles containing the color-imparting chocolate of the invention are provided to the consumer in a form that does not communicate the color of the color-imparting dye on the packaging. For example, ice cream bars having an outer coating of the color-imparting chocolate of the invention may be individually packaged in an identical manner such that the color of the color-imparting dye cannot be determined from the packaging. Ice cream bars having a selection of different color-imparting dyes (e.g., red, green, blue, etc.) can be produced, packaged individually or collectively, and sold to the consumer. The consumer then selects an ice-cream bar without having prior knowledge as to the color that will be displayed when the ice-cream bar is eaten. This is particularly entertaining for children who can select an ice-cream bar and then observe as the unknown color is imparted to their mouth and tongue.

In some instances, the chocolate compositions are mixed with a second food composition, and the color of the color-imparting dye is imparted to the second food composition. For example, a confectionary coating comprising the color-imparting chocolate of the invention can be coated onto the particles of a breakfast cereal. Upon addition of the breakfast cereal to milk, the color-imparting dye is activated and transfers its color to the milk thereby providing a novelty effect. The cereal box can be labeled to indicate that the cereal will “color the milk”, but not providing the specific color that will be imparted by the individual box of cereal. In this way, the consumer has a surprise effect when the consumer first observes the cereal being mixed with milk.

In yet another embodiment, confectionary chips or chunks of the invention may be used to prepare a dough-based bakery article wherein the dough portion of the bakery article has colored halo effects around the confectionary chips or chunks. This creates a unique appearance for the bakery article. For example, cookie dough can be prepared and the confectionary chip/chunk containing a color-imparting dye can be added to the mix near the end of the mixing cycle. During baking, the steam and moisture generated during the baking process melts at least a portion of the chip/chunks causing the color-imparting dye to create a halo effect (i.e., a colored ring encircling the chips/chunks in the cookie) around the chip/chunks in the cookie. The resulting cookie would have chocolate chips/chunks with a halo effect visible around the chips/chunks.

The following examples are presented to illustrate the present invention and to assist one of ordinary skill in making and using the same. The examples are not intended in any way to limit the scope of the invention.

### EXAMPLES

### Example 1

### Preparation of a Confectionary Composition:

The product is prepared by blending all the dry ingredients together, except food dye. Fat/oil is added at 20-30% level to form a paste. Once the paste is thoroughly mixed, the paste is refined into the desired, particle size using a refiner/grinder. The refined product is then blended together and the food dye is added. Fat/oil and emulsifier is added as necessary to meet the desired fat content and viscosity. Once the product is standardized, the food dye can then be added. For cocoa butter based product, the product is sent through a tempering process to allow for proper cocoa butter crystal formation before molding. The product can then be molded into drops/chips, wafers, square chunks or used in liquid form. Representative formulations are listed below.

### Color Changing Cocoa Chips

| Ingredient | % wt. |
|---|---|
| Sugar | 48.41 |
| Palm oil | 26.98 |
| NFDM | 14.83 |
| Vanillin | 0.038 |
| Soy lecithin | 0.15 |
| Cocoa Powder | 0.362 |
| FD&C Blue 1 Dye | 0.234 |

### Color Changing Cocoa Drizzle

| Ingredient | % wt. |
|---|---|
| Sugar | 59.43 |
| Palm & Palm Kernel Oil | 32.46 |
| Cocoa Powder | 7.97 |
| Soy lecithin | 0.3 |
| Vanilla | 0.02 |
| FD&C Green No. 3 | 0.125 |

### Color Changing Chocolate Drop

| Ingredient | % wt. |
|---|---|
| Sugar | 51.4 |
| Chocolate liquor | 42.9 |
| Cocoa Butter | 5 |
| Soy lecithin | 0.5 |
| Vanilla Sugar | 0.024 |
| FD&C Red No. 40 | 0.2 |

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

Other embodiments of this invention will be apparent to those skilled in the art upon consideration of this specification or from practice of the invention disclosed herein. Various omissions, modifications, and changes to the principles and embodiments described herein may be made by one skilled in the art without departing from the true scope and spirit of the invention which is indicated by the following embodiments.

What is claimed is:

1. A color-imparting chocolate composition comprising: (a) an anhydrous water soluble dye having a color; and (b) a chocolate composition; wherein prior to contacting the color-imparting chocolate composition with a water-based liquid, the color-imparting chocolate composition has a visual appearance that does not reveal the color of the anhydrous water-soluble dye.

2. The color-imparting chocolate composition of claim 1, wherein the composition has the visual appearance of conventional chocolate.

3. The color-imparting chocolate composition of claim 1, wherein the chocolate composition is a confectionary composition.

4. The color-imparting chocolate composition of claim 1, wherein the chocolate composition is a cocoa butter-based chocolate.

5. The color-imparting chocolate composition of claim 1, wherein the anhydrous water-soluble dye is present in an amount ranging from about 0.01 wt. % to about 1 wt. % of the color-imparting chocolate composition.

6. The color-imparting chocolate composition of claim 1, wherein the anhydrous water-soluble dye has a color selected from the group consisting of red, blue, green, and yellow.

7. The color-imparting chocolate composition of claim 1, wherein the chocolate composition comprises sweet chocolate, semisweet chocolate, milk chocolate, or white chocolate.

8. The color-imparting chocolate composition of claim 3, wherein the confectionary composition comprises: (a) a fat matrix in an amount ranging from about 20 wt. % to about 55 wt. %; (b) a nutritive/nonnutritive sweetener in an amount ranging from about 10 wt. % to about 65 wt. %; (c) milk solids in an amount ranging from about 1 wt. % to about 25 wt. %; (d) cocoa solids in an amount ranging from about 1 wt. % to about 15 wt. %; and (e) flavoring in an amount ranging from about 0.01 wt. % to about 1.5 wt. %.

9. A food article comprising the color-imparting chocolate composition of claim 1.

10. The food article of claim 9, wherein the food article is selected from the group consisting of: chocolate chips; ice-cream bars comprising an outer coating of a layer of the color-imparting chocolate; breakfast cereals containing particles of the color-imparting chocolate or containing a layer or coating of color-imparting chocolate; granola or nutrition bars containing the color-imparting chocolate of the invention present as an outer coating, a layer, or in the form of chips dispersed throughout the granola or nutrition bar; bakery inclusions, confectionary products; ready-to-eat cereals, enrobed ice cream novelty products; enrobed candies; enrobed popcorn; chocolate syrups; fondue, bars; chocolate bars/pieces; enrobed nuts; raisins; malt balls; enrobed marshmallows; truffles; glazes/drizzles; pastry fillings; chocolate mints; and sprinkles.
